(19) United States
(12) Patent Application Publication
(10) Pub. No.: US 2011/0167039 A1
(43) Pub. Date: Jul. 7, 2011

(54) DISTRIBUTED THROTTLING FOR MAILBOX DATA REPLICATION

(75) Inventors: Ayla Kol, Sammamish, WA (US); Dmitri Gavrilov, Redmond, WA (US); Bradford Clark, Duval, WA (US); Brian T. Kress, Redmond, WA (US); James C. Kleewein, Kirkland, WA (US); Gaurav Navlakha, Bellevue, WA (US)

(73) Assignee: Microsoft Corporation, Redmond, WA (US)

(21) Appl. No.: 12/652,286

(22) Filed: Jan. 5, 2010

(51) Int. Cl. G06F 17/30

(52) U.S. Cl. 707/633; 707/E17.005

(57) ABSTRACT

Distributed mailbox data replication agents are employed to adjust load on mail system resources by enabling the agents to receive a throttling policy, resource capacity, and current usage information. Each agent preparing to access the resource (e.g. provide replicated data) may then throttle itself ensuring optimum resource usage. The agents may receive the information by querying the resource, which monitors accessing agents and their types, or from a shared space instead of directly from the resource.

### BACKGROUND

Electronic mail (email) use has become an integral part of people's daily lives. Many forms of communication, personal or business, have been replaced by email exchanges. Emails not only contain textual exchanges, but many modern email systems enable integration of multi-modal communications with emails. Thus, increasing amounts of textual, audio, video, and other forms of communication data is stored in individual mailboxes and central data storage facilities as part of the vast email exchange networks.

Mailbox data is replicated to a new location (physical or virtual) as part of mailbox moves during upgrades and migrations, as part of data resiliency operations, when gathering data for search operations, as well as for mailbox level data availability solutions. Mailbox data replication solutions tend to consume large amounts of disk input/output and processing resources at the original source computers and destination computers, which compete with end user access to mailbox server resources.

Conventional tools like command-line applications or graphic user interface based wizards for mailbox data replication do not take into consideration system resource usage resulting in slowdowns or crashes in some cases. Administrators have to limit the number of simultaneous instances of such tools in order to throttle the resource consumption on mailbox servers. This manual approach is labor intensive, may not address various scenarios, and may result in degraded user experience.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to employing distributed mailbox data replication agents to adjust load on mail system resources by enabling the agents to receive a throttling policy, resource capacity, and current usage information. Each agent preparing to access the resource (e.g. provide replicated data) may then throttle itself ensuring optimum resource usage. According to some embodiments, the resource may monitor accessing agents and their types and provide that information to querying agents before they access the resource. According to other embodiments, the agents may receive their information from a shared space instead of directly from the resource.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating interactions between an agent and an email system resource according to embodiments for implementing distributed throttling in mailbox data replication;

FIG. 2 is a conceptual diagram illustrating major physical components of an email system, where distributed throttling for mailbox data replication through agents according to embodiments may be employed;

FIG. 3 is a conceptual diagram illustrating major software components of an email system, where distributed throttling for mailbox data replication through agents according to embodiments may be employed;

FIG. 4 illustrates an example scenario of three agents accessing data storage resources managed by three different servers in an email system according to embodiments;

FIG. 5 is an action diagram illustrating exchanges and operations between an agent and a mailbox server during data replication in a system according to embodiments;

FIG. 6 is a networked environment, where a system according to embodiments may be implemented;

FIG. 7 is a block diagram of an example computing operating environment, where embodiments may be implemented; and

FIG. 8 illustrates a logic flow diagram for employing distributed throttling in mailbox data replication according to embodiments.

### DETAILED DESCRIPTION

As briefly described above, distributed agents may be used to throttle themselves in accessing a system resource for mailbox data replication based on a capacity of the resource and current usage. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for managing email systems and data replication for email systems. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

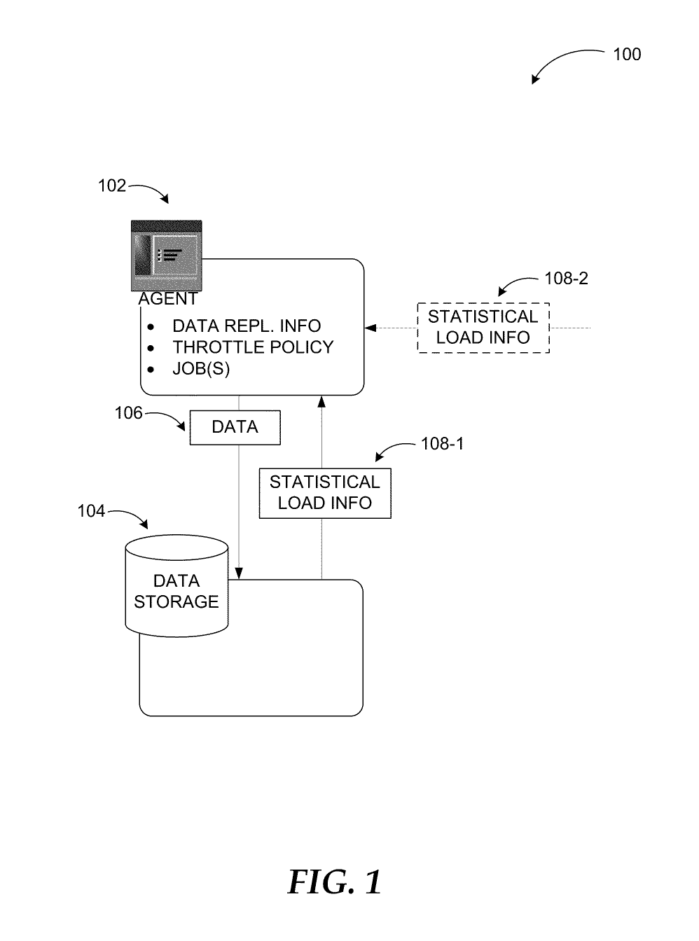

Referring to FIG. 1, conceptual diagram 100 illustrating interactions between an agent and an email system resource according to embodiments for implementing distributed throttling in mailbox data replication, is illustrated.

As discussed above, mailbox data is replicated as part of a number of mailbox operations straining resource capacity in some cases—when multiple clients attempt to replicate large amounts of data simultaneously. In modern email systems, mailbox replication may be performed by a set of distributed background services with the intention to reduce the administrative involvement and to optimize mailbox replication throughput. In such an architecture according to embodiments, there is opportunity to remove the manual administrative process to throttle resources consumption on mailbox servers.

Distributed background services—also referred to as mailbox data replication agents—may interact with the same set of mailbox servers and mailbox databases. Since agents are distributed and do not directly communicate with each other, throttling concurrent data replications destined to (or sourced from) a given mailbox server or mailbox database is a challenge. In a system according to some embodiments, each agent may be configured to identify itself to the resource owner (e.g. the storage process running on each mailbox server). The resource owner may maintain a concurrency count and report this number to agents to react to. According to other embodiments, the agents may receive the information to throttle data replications from a shared space instead of the resource owner (e.g. where the resource is completely agnostic). According to further embodiments, a throttling service may implement throttling logic (intelligence) that starts the data replication agents, where each agent is responsible for a particular data replication job. In that case, the throttling service may keep track of active replication agents and throttle them based on information from data replication resource(s).

As shown in diagram 100, agent 102 receives data replication information (source, destination, capacity of resource, etc.), throttle policy, and one or more data replication jobs. According to one embodiment, agent 102 may query the resource (e.g. data storage 104) and receive statistical load information 108-1 from the resource. This information may include simply a number of agents accessing the resource currently. The information may also include agent types, amount of data being transferred, a capacity of the resource to receive data, and similar information, as well. According to another embodiment, agent 102 may receive statistical load information 108-2 from another source such as a shared space for the agents instead of directly receiving the information from the resource.

If the resource capacity is not full, agent 102 may begin sending data 106 to be replicated to data storage 104. If according to the capacity of the resource is full, agent 102 may throttle itself according to the throttle policy and submit the data at a later time enabling optimum consumption of system resources.

An agent according to embodiments, may maintain more or less information than discussed above. The resource may include any component of an email system in addition to data storage facilities. The agent and the resource may be part of the same system or part of distinct systems. Moreover, a throttling service as mentioned above may manage the agents as well. Communication between the agent and other components of the system such as the resource may be facilitated employing any number of protocols.

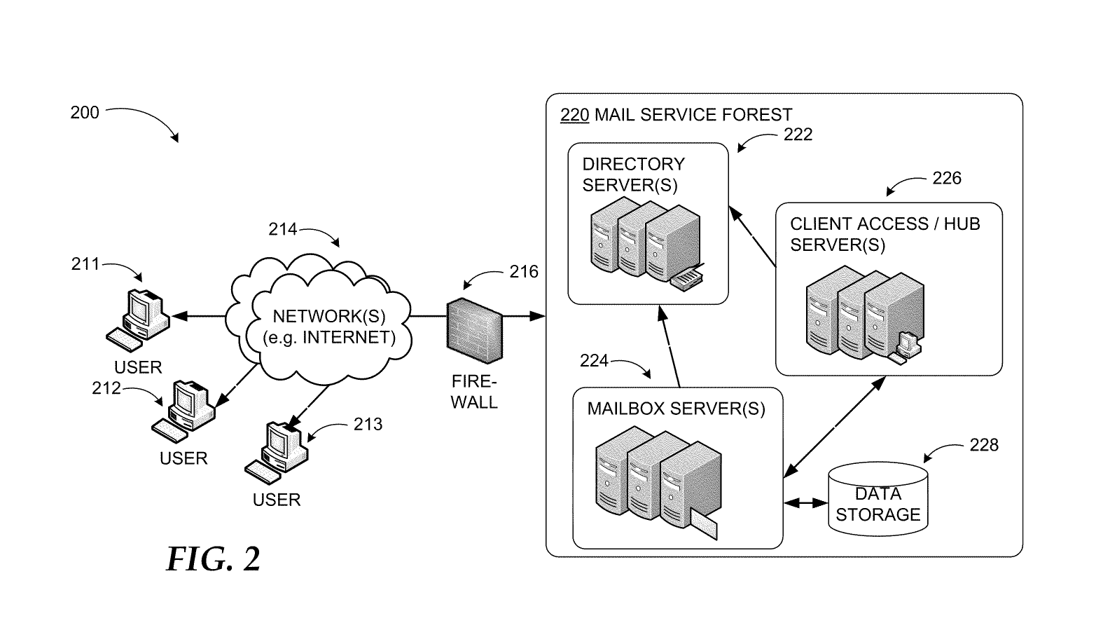

FIG. 2 is a conceptual diagram illustrating major physical components of an email system, where distributed throttling for mailbox data replication through agents according to embodiments may be employed.

In an example system, such as the one shown in diagram 200, users 211-213 may communicate with a mail service over network(s) 214, which may include the Internet. To ensure security, firewall 216 may be employed between the network(s) 214 and mail service forest 220, which includes the servers executing various applications associated with the mail service.

Mail service forest 220 may include directory servers 222, which enable administrators to assign policies, deploy software, and apply updates to an organization. Directory servers 222 may store information and settings in a central database. Directory servers 222 may manage networks of computing devices varying from a small installation with a few computers, users and printers to tens of thousands of users, many different domains and large server farms spanning many geographical locations.

Mail service forest 220 may also include mailbox servers 224 managing the mailboxes, public folders, and data replication solutions. Mailbox servers 224 may employ local or remote data storage 228 to store mailbox and other data. Another group of servers that may be included in mail service forest 220 is client access/hub servers 226. Client access/hub servers 226 may manage email related applications, protocols, and mail services for users 211-213, as well as route communications. Data replication solutions may be implemented as log shipping, hardware based solutions, and comparable ones.

Applications executed on client devices for users 211-213 or by client access/hub servers 226 may generate data for replication through archiving services, search operations, import/export operations, mailbox moves (e.g. upgrade or new account setup), and similar ones. Data replication policies may define which portion (or all) of the data is to be replicated, how frequently it is to be replicated, to where (destination) the data is to be replicated, and similar parameters. Agents running on client devices, client access/hub servers 226, or directory servers 222 may submit the data to be replicated to mailbox servers 224 managing data storage employing a throttling mechanism as discussed above. More examples of such a mechanism are described in detail below.

The example system of FIG. 2 is for illustration purposes, and does not constitute a limitation on embodiments. A system implementing distribute throttling for mailbox data replication may be implemented in any system with fewer or additional physical and software components. Moreover, the applications and services discussed above may be executed by other servers, in other configurations, using the principles described herein.

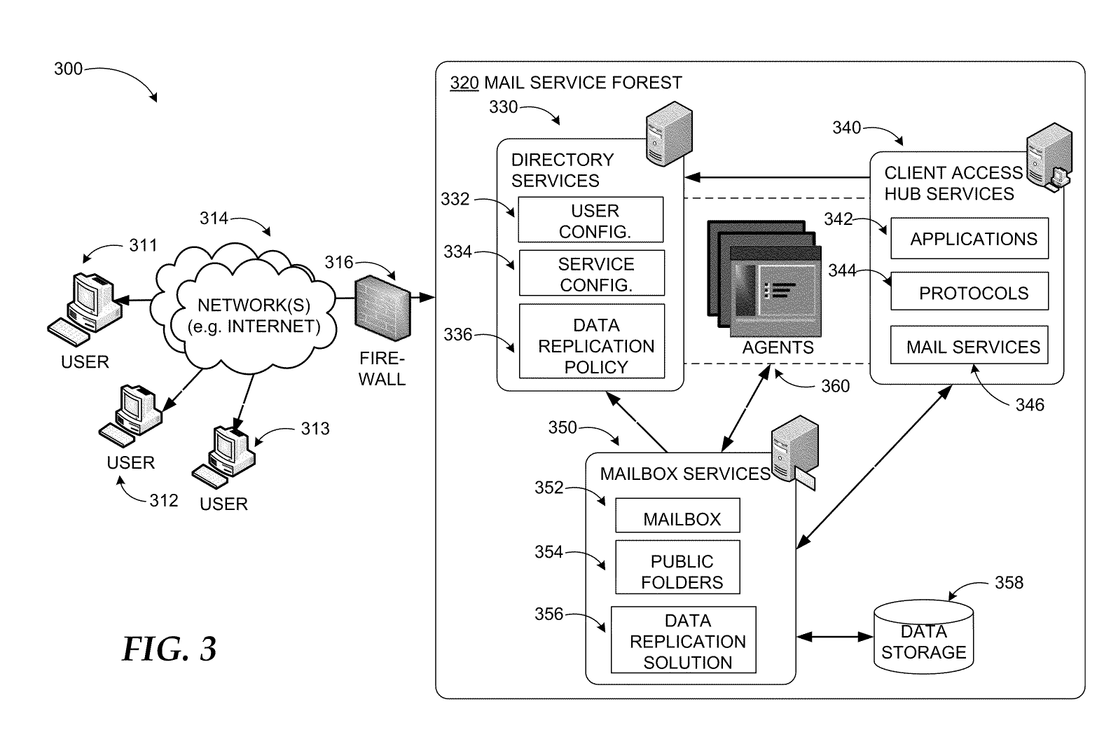

FIG. 3 is a conceptual diagram illustrating major software components of an email system, where distributed throttling for mailbox data replication through agents according to embodiments may be employed.

In diagram 300, users 311-313 communicating over network(s) 314 and through firewall 316 are routed by the client access/hub services 340 of mail service forest 320. Mailbox services 350 manage mailboxes 352, public folders 354, and data replication solution 356. Mailbox services 350 may also manage local storage (358) of email data. Client access/hub services 340 manage protocols 344 and email related applications 342 in addition to mail services 346. Examples of applications 342 may include search applications, import/export applications, archive applications, and comparable ones. Directory services 330 manage user configurations 332, service configurations 334, and data replication policy 336. An example of directory services 330 is ACTIVE DIRECTORY® service of Microsoft Corp. of Redmond, Wash.

Data to be replicated may be generated by applications 342 or by mailbox move operations and submitted through distributed agents 360 to mailbox services 350 for storage in local or remote data stores according to a data replication policy. Agents 360 may be managed by client devices for users 311-313, directory services 330, or client access/hub services 340. According to one implementation, agents 360 may not be aware of each other. However, they are aware of their own kind.

In a system according to some embodiments, agents 360 may have a common identity to distinguish them from other consumers of the mailbox services 350. A resource owner process at mailbox services 350 may keep track of how many mailbox data replication agents are accessing itself (i.e. how many data replication jobs are being executed) and provide this information to every agent that queries it. Agents 360 may regularly query the number of pipelines consumed by their own kind against a specific mailbox server and/or a specific database and throttle themselves back automatically by comparing the cumulative consumption against agent's throttling configuration settings (throttling policy).

While the example system in FIG. 3 has been described with specific components such as directory services, public folders, etc., embodiments are not limited to systems according to this example configuration. An email system employing distributed throttling for mailbox data replication through agents may be implemented in other systems and configurations employing fewer or additional components. Furthermore, embodiments are not limited to email systems. Indeed, any networked system implementing data replication may implement a throttling mechanism using the principled discussed herein. For example, unified communication systems managing textual, audio, video, data, and other communication modalities may employ distributed agents to replicate data generated by the communication systems (e.g. recordings of audio/video conversations) in a throttled manner according to embodiments.

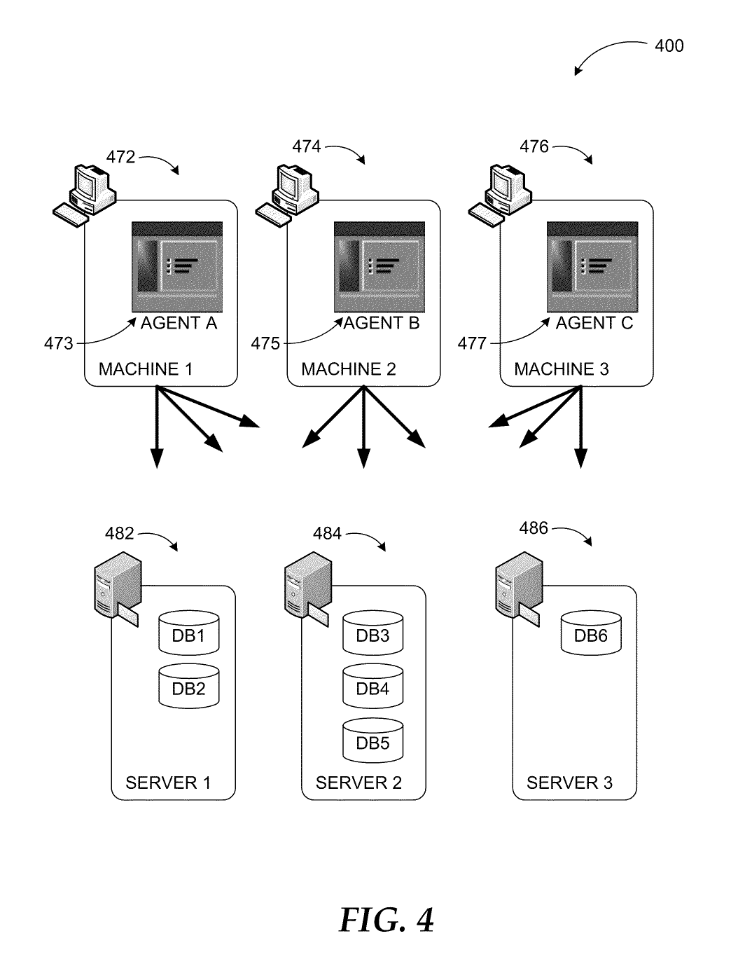

FIG. 4 illustrates an example scenario of three agents accessing data storage resources managed by three different servers in an email system. Diagram 400 illustrates the distributed nature of data replication and adjustment of resource consumption to optimize system usage according to embodiments.

According to the displayed example scenario, agent A, agent B, and agent C (472, 474, and 476) may be executed on machines 1, 2, and 3 (473, 475, and 477) each agent managing a different data replication job. As discussed previously, agents A, B, and C (472, 474, and 476) may have information on throttling policy, replication source and destination. The destinations for data replication may include databases 1 through 6 managed by servers 1, 2, and 3 (482, 484, and 486). As shown in diagram 400, each server may manage a different number of databases and have varying data input/output capacity and/or processing capacity.

According to one example scenario, throttling may be configured to allow only one data replication per database, and two data replications per mailbox server. In this case when agent A (472) starts a replication job writing data to DB1, and agent B (474) checks the load statistics on server 1 (482), agent B (474) determines that a new replication job for DB1 is not available. Since the server limit of two has not been reached, however, agent B (474) may start a replication job for DB2 (also managed by server 1) if one exists. While agent A (472) and agent B (474) are working on the data replication requests they received, agent C (476) may query server 1 (482). In that case, agent C (476) may compare the ongoing data replications—which is 2—against the throttling configuration—which is again 2—and it does not does not accept a new data replication job for server 1 (482). If there are any outstanding data replication jobs for the other two servers, agent C (476) may accept a new data replication job for one of those servers until server 1 (482) becomes available again.

A data replication job according to embodiments is not limited to having all of its data delivered by a single/specific data replication agent. In some cases, data may be delivered in batches and the throttling process may enable different agents to take turns in delivering different batches of data for the same replication job.

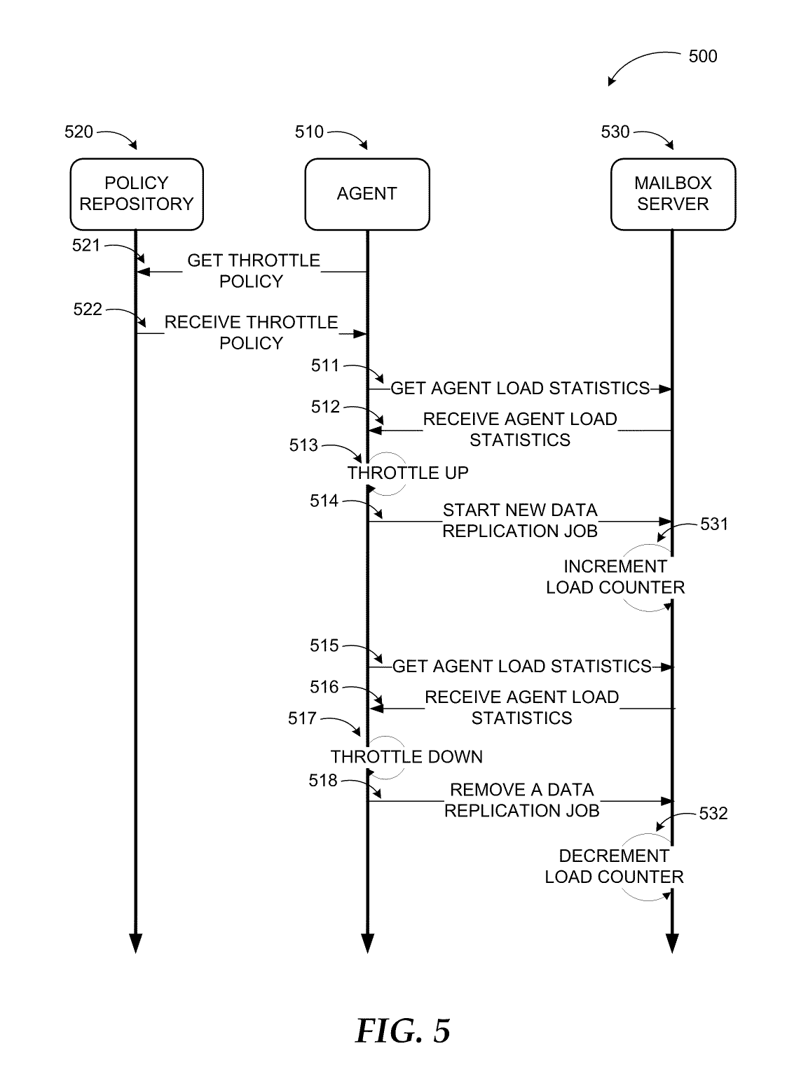

FIG. 5 is an action diagram illustrating exchanges and operations between an agent and a mailbox server during data replication in a system according to embodiments. As shown in diagram 500, agent 510 receives throttle policy (“get throttle policy” 521 and “receive throttle policy” 522) from policy repository 520. According to further embodiments, the agents may receive and process additional information such as other consumers of the resource, available resource capacity, how much data is being provided to the resource, and the like. The throttle policy may define thresholds based on resource capacity and consumers of the resource. For example, a simple policy may define three mailbox replication agents for a given mailbox server. Of course, the policy may also be more complex and include more detailed decision points.

Mailbox server 530 may also vary across a spectrum in its capabilities. On one end of the spectrum, mailbox server 530 may be completely agnostic and not aware of any agents using its resources. In that scenario, the agents may receive usage information from a different source such as a shared space for agents, where each agent records its current use of a system resource. On the other end of the spectrum, mailbox server 530 may keep track of detailed information such as its own capacity, different types of consumers is its resources, and the like, and provide that information to a querying agent. As mentioned previously, both agent 510 and mailbox server 530 may handle any form of networked communication and are not limited to text-based email services.

According to the example shown in diagram 500, the exchange between agent 510 and mailbox server 530 may begin with the agent requesting the agent 510 querying mailbox server 530 and request an load statistics (511). Upon receiving the agent load statistics (512), the agent 510 may compare that to the throttle policy and determine that it can throttle up (513), i.e. start a new data replication job (514) with the mailbox server 530. In response, mailbox server 530 may increment its load counter (531).

In another scenario, where the server may have already reached its capacity, agent 510 may request the load statistics (515), receive the agent load statistics (516) determining the limit has been reached according to the throttle policy, and throttle down (517), i.e. reject the job or remove a data replication job from the server (518). In that case, mailbox server 530 may decrement its load counter (532).

The example scenarios of agent-server interactions discussed above are for illustration purposes only and do not constitute a limitation on embodiments. Other interactions, configurations, and agent behaviors may also be implemented using the principles described herein.

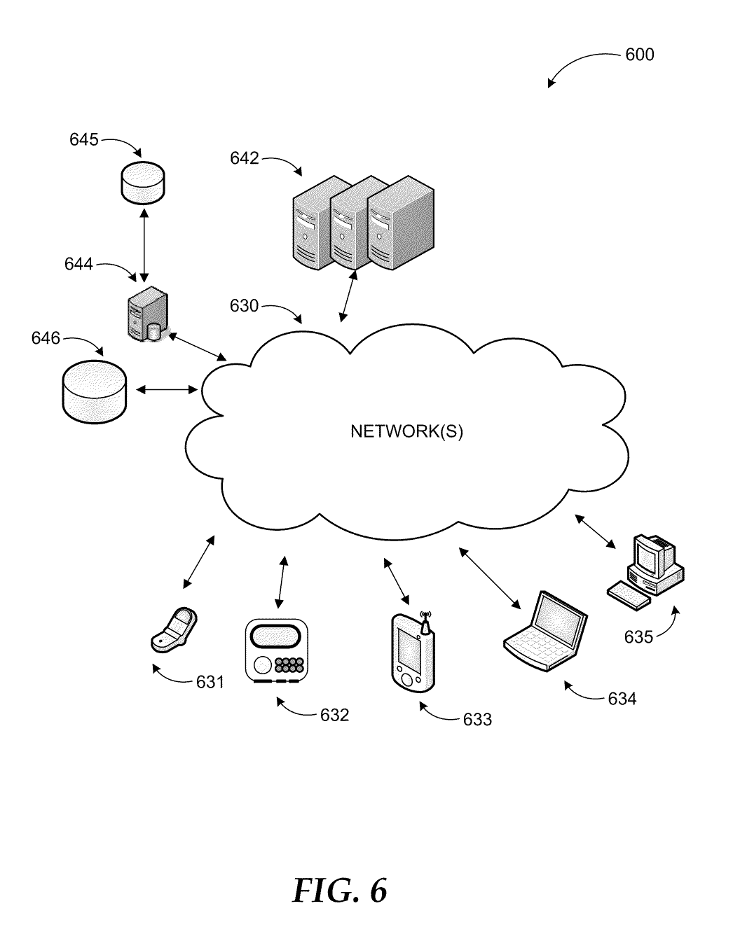

FIG. 6 includes diagram 600 of an example networked environment, where embodiments may be implemented. A platform providing data replication services within email systems may be implemented via software executed over one or more servers 642 such as a hosted service. The platform may communicate with client applications on individual computing devices such as a smart phone 631, a vehicle mount computer 632, a handheld computer 633, a laptop computer 634, and a desktop computer 635 ('client devices') through network(s) 630.

As discussed above, modern email systems include many aspects and components such as mailbox/public folder services, data replication, and related applications data push data into the system. Servers 642 may execute these different aspects centrally or in a distributed fashion (e.g. in conjunction with applications executed on client devices 631-635) and interact through one or more of the network(s) 630.

A service or an application executed on client devices 631-635 may attempt to push data into the mailbox of a user as part of an email related operation through a distributed agent. The agent may receive throttling information as discussed above and use that information to throttle itself up or down. Replicated data may be stored in one or more locations such as data stores 646 directly or data stores 645 through data server 644.

Network(s) 630 may comprise any topology of servers, clients, Internet service providers, and communication media. A system according to embodiments may have a static or dynamic topology. Network(s) 630 may include secure networks such as an enterprise network, an unsecure network such as a wireless open network, or the Internet. Network(s) 630 may also coordinate communication over other networks such as Public Switched Telephone Network (PSTN) or cellular networks. Furthermore, network(s) 630 may include short range wireless networks such as Bluetooth or similar ones. Network(s) 630 provide communication between the nodes described herein. By way of example, and not limitation, network(s) 630 may include wireless media such as acoustic, RF, infrared and other wireless media.

Many other configurations of computing devices, applications, data sources, and data distribution systems may be employed to implement an email system distributed throttling for mailbox data replication. Furthermore, the networked environments discussed in FIG. 6 are for illustration purposes only. Embodiments are not limited to the example applications, modules, or processes.

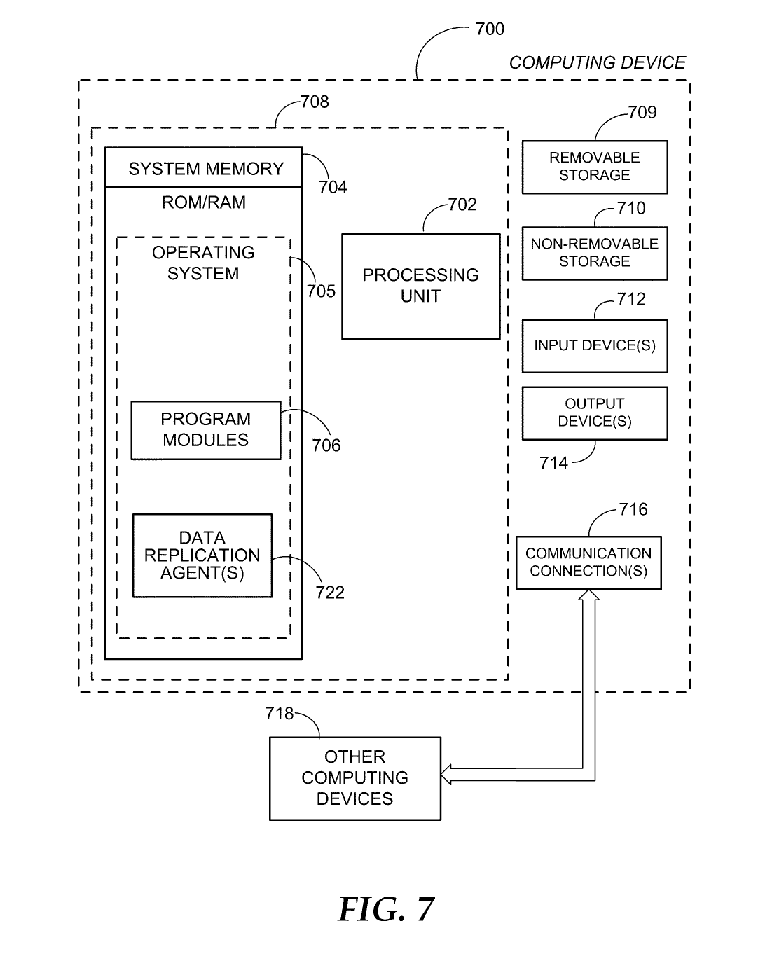

FIG. 7 and the associated discussion are intended to provide a brief, general description of a suitable computing environment in which embodiments may be implemented. With reference to FIG. 7, a block diagram of an example computing operating environment for an application according to embodiments is illustrated, such as computing device 700. In a basic configuration, computing device 700 may be a server managing mail operations as part of an email system and include at least one processing unit 702 and system memory 704. Computing device 700 may also include a plurality of processing units that cooperate in executing programs. Depending on the exact configuration and type of computing device, the system memory 704 may be volatile (such as RAM), non-volatile (such as ROM, flash memory, etc.) or some combination of the two. System memory 704 typically includes an operating system 705 suitable for controlling the operation of the platform, such as the WINDOWS ® operating systems from MICROSOFT CORPORATION of Redmond, Washington. The system memory 704 may also include one or more software applications such as program modules 706 and data replication agent(s) 722.

Data replication agent(s) 722 may perform various replication related operations including receiving load statistics information from a resource owner process, comparing the load statistics information to the throttle policy, and deciding whether to perform a new replication job or not based on the current load statistics and the throttle policy as discussed above. This basic configuration is illustrated in FIG. 7 by those components within dashed line 708.

Computing device 700 may have additional features or functionality. For example, the computing device 700 may also include additional data storage devices (removable and/or non-removable) such as, for example, magnetic disks, optical disks, or tape. Such additional storage is illustrated in FIG. 7 by removable storage 709 and non-removable storage 710. Computer readable storage media may include volatile and nonvolatile, removable and non-removable media implemented in any method or technology for storage of information, such as computer readable instructions, data structures, program modules, or other data. System memory 704, removable storage 709 and non-removable storage 710 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 700. Any such computer readable storage media may be part of computing device 700. Computing device 700 may also have input device(s) 712 such as keyboard, mouse, pen, voice input device, touch input device, and comparable input devices. Output device(s) 714 such as a display, speakers, printer, and other types of output devices may also be included. These devices are well known in the art and need not be discussed at length here.

Computing device 700 may also contain communication connections 716 that allow the device to communicate with other devices 718, such as over a wired or wireless network in a distributed computing environment, a satellite link, a cellular link, a short range network, and comparable mechanisms. Other devices 718 may include computer device(s) that execute communication applications, other directory or policy servers, and comparable devices. Communication connection(s) 716 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

A method for implementing distributed throttling for data replication in a networked communication system according to embodiments includes receiving a throttle policy at a data replication agent, receiving a current status information associated with a data replication resource, comparing the current status information to the throttle policy, and executing a data replication job if the current status information satisfies the throttle policy. The method further includes querying a shared space for data replication agents or the data replication resource regarding the data replication resource's current status and receiving the current status information from the shared space or the resource directly.

The throttle policy may define one or more threshold of a number of data replication agents and/or other consumers of the data replication resource allowed to access the data replication resource simultaneously. The current status information may includes a current count of data replication jobs or other consumers accessing the data replication resource and the load statistics information may be compared to the one or more thresholds defined by the throttle policy. The current status information may further include a capacity of the resource, a number of agents currently accessing the resource, a type of agents currently accessing the resource, and/or an amount of data transferred by each accessing agent.

The throttle policy may also define one or more thresholds for each data replication resource based on the capacity of the resource, the number of agents currently accessing the resource, the type of agents currently accessing the resource, and/or the amount of data transferred by each accessing agent. The data replication resource may be for receiving data from a data store or for providing data to a data store associated with one or more mailboxes.

The data replication agent may wait until the throttle policy is satisfied, reject the data replication job, or try a different data replication resource if the current status information fails to satisfy the throttle policy. The data replication agent may identify itself and its type to the data replication resource (or a process managing the resource), which is monitoring the count of data replication jobs currently associated with the data replication resource. The data replication agent may receive the throttle policy from the process managing the data replication resource or a data replication policy service. The data replication resource may also maintain an load counter keeping track of active data replication jobs for the data replication resource.

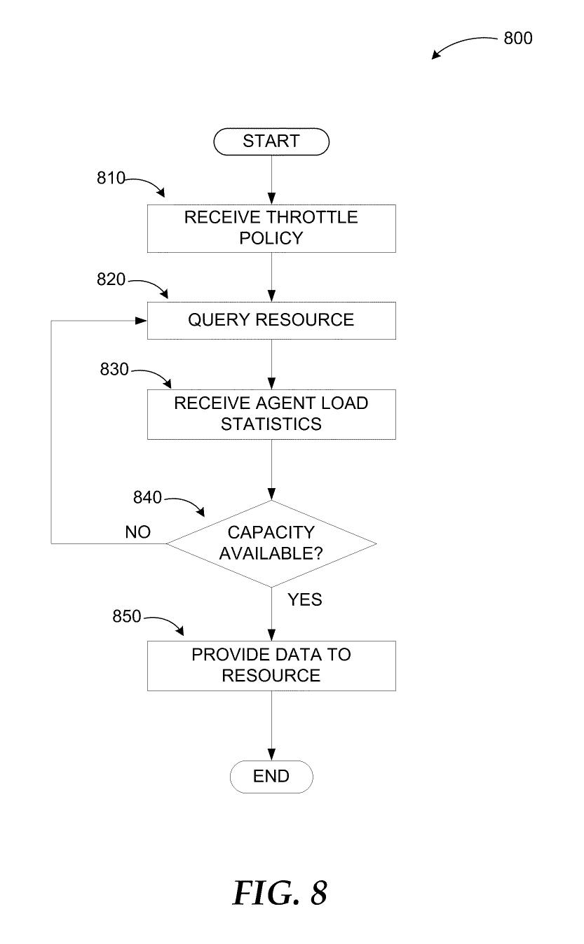

FIG. 8 illustrates a logic flow diagram for process 800 of employing distributed throttling in mailbox data replication according to embodiments. Process 800 may be implemented as part of an email system that facilitates data replication.

Process 800 begins with operation 810, where an agent receives throttle policy defining a threshold of data replication jobs of a particular kind for a given resource. At operation 820, the agent queries a resource regarding its current status. The query may be sent upon receiving a data replication job or on a periodic basis. The status may include load statistics information ranging from a simple load count to more detailed information such as current capacity, etc.

Upon receiving the load statistics at operation 830, the agent checks it against the throttle policy and makes a determination at decision operation 840 whether the resource is available for another replication job or not. If the resource is not available, processing returns to operation 820, where the agent continues querying the resource. If the resource is not available, the agent may also wait until the policy is satisfied, reject the replication job, or try a different replication resource. If the resource is available, based on the throttle policy, the agent may begin executing the new replication job and provide the data to be replicated to the resource at operation 850.

The operations included in process 800 are for illustration purposes. An email service with distributed throttling for data replication may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for implementing distributed throttling for data replication in a networked communication system, the method comprising:
receiving a throttle policy at a data replication agent;
receiving a current status information associated with a data replication resource;
comparing the current status information to the throttle policy; and
executing a new data replication job if the current status information associated with the new data replication job satisfies the throttle policy.

2. The method of claim 1, wherein receiving the current status information includes:
querying a shared space for data replication agents regarding the data replication resource's current status; and
receiving the current status information from the shared space.

3. The method of claim 1, wherein receiving the current status information includes:
querying the data replication resource regarding the resource's current status; and
receiving the current status information from the data replication resource.

4. The method of claim 3, further comprising:
submitting one of: a periodic query and a query upon receipt of a data replication job to the data replication resource prior to receiving the current status information.

5. The method of claim 1, wherein the throttle policy defines at least one threshold of a number of data replication agents to access the data replication resource simultaneously.

6. The method of claim 5, wherein the current status information includes a current count of data replication jobs being executed on the data replication resource and comparing the current status information to the throttle policy comprises:
comparing the current count to the threshold.

7. The method of claim 1, wherein the current status information includes at least one from a set of: a capacity of the resource, a number of agents currently accessing the resource, a type of agents currently accessing the resource, and an amount of data transferred by each accessing agent.

8. The method of claim 7, wherein the throttle policy defines at least one threshold for each data replication resource based on at least one from a set of: the capacity of the resource, the number of agents currently accessing the resource, the type of agents currently accessing the resource, and the amount of data transferred by each accessing agent.

9. The method of claim 1, wherein the data replication resource is for one of: receiving data from a data store and providing data to a data store.

10. The method of claim 1, wherein the networked communication system includes an email system and the data replication job includes replication of data from one of:
a search application, an archiving application, a database application, a data import application, a data export application, and a data move operation between mailboxes.

11. The method of claim 1, wherein the data replication agent is configured to one of: wait until the throttle policy is satisfied, reject the data replication job, and try a different data replication resource if the current status information fails to satisfy the throttle policy.

12. A system for facilitating data replication in electronic mail services implementing distributed throttling in data replication, the system comprising:
a first server performing actions including:
manage a data replication policy associated with at least one mailbox managed by the system, wherein the data replication policy defines a throttle policy for a number of data replication jobs to be executed on a data replication resource simultaneously;
a second server performing actions including:
manage interactions of an application providing data to the at least one mailbox with the system;
a third server performing actions including:
manage the data replication resource associated with the at least one mailbox, wherein the third server monitors a number of data replication jobs currently executed on the data replication resource; and
a data replication agent performing actions including:
receive the throttle policy;
receive a current load status information from the third server;
compare the current load status information to the throttle policy; and
one of: accept and reject a new data replication job based on the comparison.

13. The system of claim 12, wherein the data replication agent is executed on one of: the first server, the second server, and a client device.

14. The system of claim 12, wherein the data replication agent is further configured to identify itself and its type to the third server monitoring the number of data replication jobs currently executed on the data replication resource.

15. The system of claim 14, wherein the data replication agent is further configured to decide whether to accept the new data replication job based on a number of agents of its own type currently accessing the data replication resource.

16. The system of claim 12, wherein the third server is further configured to increment a load counter in response to a new data replication job being executed and decrement the load counter in response to an existing data replication job being removed from the data replication resource.

17. A computer-readable storage medium with instructions stored thereon for implementing distributed throttling of data replication in an email system, the instructions comprising:
receiving a throttle policy defining at least one threshold of a number of data replication jobs to be executed on a data replication resource simultaneously;
querying a process managing the data replication resource regarding a current load count of data replication jobs associated with the data replication resource;
receiving the current load count from the process managing the data replication resource;
comparing the current load count to the at least one threshold defined by throttle policy; and
if the current load count satisfies the throttle policy, providing data to be replicated to the data replication resource; else
one of: waiting until the throttle policy is satisfied, rejecting a data replication job for the data to be replicated, and trying a different data replication resource.

18. The computer-readable medium of claim 17, wherein the instructions further comprise:
receiving information associated with other consumers of the data replication resource currently accessing the data replication resource; and
comparing the information associated with the other consumers of the data replication resource to another threshold defined by the throttle policy.

19. The computer-readable medium of claim 17, wherein the instructions further comprise:
receiving the throttle policy from one of: the process managing the data replication resource and a data replication policy service.

20. The computer-readable medium of claim 17, wherein the process managing the data replication resource is configured to maintain a load counter keeping track of data replication jobs of a particular type executed on the data replication resource.
